(19) United States
(12) Patent Application Publication
(10) Pub. No.: US 2007/0196036 A1
(43) Pub. Date: Aug. 23, 2007

(54) Seal for hydrostatic bearing arrangement

(76) Inventor: Rolf Eckstein, Roedental (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/708,038

(22) Filed: Feb. 20, 2007

(30) Foreign Application Priority Data
Feb. 20, 2006 (DE) 10 2006 007 736.9

(51) Int. Cl. F16C 32/06

(52) U.S. Cl. 384/119

(57) ABSTRACT

The invention relates to a tool spindle (26) for machining centers for the machining of workpieces. The tool spindle (26) is mounted in an extendable manner in a spindle slide (16). The tool spindle (26) is accommodated in a radial hydrostatic bearing. The radial hydrostatic bearing has a bush (72) fitted in the spindle slide (16). The radial hydrostatic bearing is mounted on at least one side in the direction of rotation and in the axial direction.

### REFERENCE TO FOREIGN PATENT APPLICATION

This application is based on German Patent Application No. 10 2006 007 736.9filed 20 Feb. 2006, upon which priority is claimed.

### BACKGROUND OF THE INVENTION

1. Field of the Invention

The invention relates to a seal of a radial hydrostatic bearing arrangement for machine tools, in particular for mounting a traversable tool spindle in a spindle slide.

2. Prior art

A headstock having a main bearing arrangement of the spindle can be seen from the company brochure “Union Boring and Milling Machines and Machining Centers, model 100/110, table type” of Union Werkzeugmaschinen GmbH Chemnitz, Clemens-Winkler-Straβe 5, D-09116 Chemnitz, brochure code T-DC 10-11-9d. According to this known device, a sleeve is mounted on the spindle, which has a tool holder at the front end. The sleeve is arranged in a casing by means of rolling-contact bearings, the casing accommodating the spindle and the sleeve being driven via a belt drive. To this end, an axial section of the casing is designed as a belt pulley, around which three belts revolve. The belts are driven by a drive accommodated above the boring spindle in a housing part arranged above the spindle slide. As can be seen from the drawing “main bearing arrangement” of the cited company brochure of Union Werkzeugmaschinen GmbH, the sleeve in which the tool spindle is guided is mounted by means of rolling-contact bearings in the spindle slide, which is traversable in the axial direction. The gap between sleeve and boring spindle is in the order of magnitude of between 0.008 and 0.015 mm. If the tool spindle disclosed in the company brochure strikes the workpiece to be machined, exchange of a damaged tool spindle may be necessary, which involves a resetting time of several days.

DE 28 45 968 A1 or DD 201 818 disclose an arrangement of functional elements of a work spindle, in particular for a coordinate boring machine. According to this solution, a work spindle is disclosed which is used in particular in coordinate boring machines and which, in order to realize highly precise rotary and translatory movements, is mounted and guided in a rotary and axially displaceable manner in at least two hydrostatic multi-pocket bearings arranged in the housing, or in bearings designed in another manner. Functional elements are used iri order to transmit the rotary and translatory movements to a hollow work spindle. These functional elements comprise a hollow shaft, a threaded hollow spindle and a fixed rod, which are arranged so as to project into the hollow work spindle. The rotary movement transmitted by the hollow shaft projecting telescopically into the hollow work spindle is transmitted to the hollow work spindle by positive locking. The hollow shaft connected to the main drive is mounted in a rotatable, but axially fixed manner in the housing. The translatory movement is transmitted to the hollow work spindle by the threaded hollow spindle which projects telescopically into the hollow shaft. The spindle-head-side end of the threaded hollow spindle is connected to the hollow work spindle so as to be rotatable via an axial bearing arrangement, but in an axially fixed manner. The drive-side part of the threaded hollow spindle engages in a nut which is connected to a secondary drive and is mounted so as to be rotatable in the housing, but in an axially fixed manner. The threaded hollow spindle itself is secured against rotation via positive locking and is guided in an axially displaceable manner by the rod, which in turn projects telescopically into said threaded hollow spindle and is connected to the housing in a rotationally locked and fixed manner.

According to the solution known from DE 28 45 968 A1, the torque of the main drive is transmitted by a hollow shaft, whereas the feed force of the secondary drive is transmitted via a threaded hollow spindle. The hollow work spindle according to this solution is mounted and guided in a rotatable and axially displaceable manner by two hydrostatic multi-pocket bearings arranged in the housing. The hydrostatic multi-pocket bearings are fed with pressure medium via a supply system. A disadvantage with the solution that can be seen from DE 28 45 968 A1 or DD 201 818 is the fact that that end of the tool spindle which points towards the workpiece is not sealed and consequently the oil volume required in the front multi-pocket bearing for building up the pressure-medium cushion can escape via the gap pointing towards the workpiece to be machined at the end face of the tool spindle. Firstly, this constant leakage results in an increased pressure level in the pressure-medium supply system of the hydrostatic multi-pocket bearing pointing towards the workpiece; secondly, a constant leakage of pressure medium occurs over the operating period. Furthermore, the solution that can be seen from DE 28 45 968 A1 or DD 201 818 has the disadvantage of small extension travel, play occurs in the force transmission to the boring spindle in the course of the operating period on account of the belt drive, and the rotational rigidity of the boring spindle changes with the extension travel in such a way as to impair the machining quality.

### SUMMARY OF THE INVENTION

In view of the prior art, the primary object of the present invention is to provide a seal of a radial hydrostatic bearing for a tool spindle which is used in a machining centre.

The seal, proposed according to the invention, of a radial hydrostatic bearing for mounting the tool spindle on the workpiece-side end is distinguished by the fact that a number of pocket-shaped recesses supplied with pressure medium are formed over its axial length, the pocket-shaped recesses being sealed. The axial extent of the pockets firstly enables the build-up of a relatively wide pressure cushion and secondly limits the gap. The distance, unavoidable in hydrostatic bearings, between the fixed part of the radial hydrostatic bearing, which is formed by a bush surrounding the tool spindle, and which is determined on the other hand by the outer circumferential surface of the tool spindle, can be kept to a minimum. The extremely small gap results in a radial bearing arrangement free of play and in highly precise longitudinal guidance. In a preferred embodiment variant, the pockets of the radial hydrostatic bearing are designed to be beveled on their side pointing towards the lateral surface of the tool spindle. Due to the beveled design, rapid exchangeability of the tool spindle is possible after “striking” has occurred, i.e. after an unintentional collision between the tool spindle and the workpiece to be machined. The easy exchangeability is firstly possible due to the beveled regions of the pocket part of the radial hydrostatic bearing and is secondly assisted by the fact that the tool spindle is connected to a gearing by an overload safety device which can be easily fitted and removed, by means of which gearing the tool spindle and the cutting tool accommodated thereon or the unit connected to the spindle slide are coupled.

The sealed hydrostatic bearing, proposed according to the invention, of the tool spindle in a spindle slide traversable either horizontally or vertically is distinguished by a seal at least at the tool-side end of the spindle slide. To this end, the seal is designed to be split into a radial seal and an axial seal. Whereas the radial seal is formed by a sealing ring surrounding the lateral surface of the tool spindle, the axial seal of the tool spindle in the region of the end-face tool holder is effected by a preferably pneumatically mounted ring which has at least two sealing elements on its side pointing towards the lateral surface of the tool spindle and which rotates with the rotation of the tool spindle relative to its pneumatic bearing arrangement. As a result, the power loss on account of the bearing friction can be significantly reduced compared with solutions hitherto known from the prior art. The axial seal moves relative to the pneumatic bearing with minimum friction and is moved relative to the pneumatic bearing by the rotation of the tool spindle. A relative movement between the sealing elements bearing on the circumferential surface of the tool spindle and the circumferential surface of the tool spindle does not occur. The ring having the sealing elements is preferably fixed pneumatically and covers the lateral surface of the tool spindle over an axial region and therefore develops a surface sealing effect. In addition, retention of the pressure-medium supply unavoidably escaping from the radial hydrostatic bearing is possible by means of two sealing elements connected in series in the feed direction of the tool spindle, which can be extended axially from the spindle slide.

The easy exchangeability of the tool spindle, which is accommodated in the spindle slide in a traversable manner, is achieved by virtue of the fact that the bush forming the fixed pocket part of the radial hydrostatic bearing can be removed from the interior of the spindle slide after the machining plate at the end face of the spindle slide has been removed. To this end, it is merely necessary to release the overload safety device between the output of the gearing, rotationally driving the tool spindle, and the tool spindle. Compared with hitherto known solutions in which the exchange of the tool spindle takes several days, this can be done within a considerably shorter period when using the solution according to the invention, thus, for example, within a day.

The heating occurring during operation due to the cutting operation at the tool of the tool spindle advantageously does not have an effect on the functioning of the guide, i.e. on the gap inside the radial hydrostatic bearing. A thermal expansion of the tool spindle occurring in the course of operation, i.e. an increase in diameter of the tool spindle, is absorbed by the gap of the hydrostatic bearing. The unavoidable heating of the tool spindle occurring during operation is decisively reduced by the seal, proposed according to the invention, of the hydrostatic bearing at least at one end by virtue of the fact that the power loss due to friction can be decisively reduced by the use of the pneumatic bearing arrangement at least at the axial seal. As already explained above, the sealing elements of the axial seal are located in a fixed position on the circumference of the tool spindle; the ring, accommodating the sealing elements, of the axial seal therefore rotates with the tool spindle, but relative to the pneumatic bearing arrangement accommodated in the housing, as a result of which the power loss is significantly reduced.

### BRIEF DESCRIPTION OF THE DRAWINGS

The invention is described in more detail below with reference to the drawing, in which:

FIG. 1 shows a side view of a slide which is traversable on a machining centre and on which a spindle slide accommodating a tool spindle is formed;

FIG. 2 shows a section through that end of the spindle slide which points towards the workpiece to be machined, with a tool spindle accommodated therein, which is mounted in a bush by a radial hydrostatic bearing,

FIG. 3 shows an enlarged illustration of the pocket design inside the radial hydrostatic bearing,

FIG. 4 shows a schematic illustration of the seal of the radial hydrostatic bearing at the tool spindle, and

FIG. 5 shows an illustration of the radial hydrostatic bearing and of the seal in the axial and radial directions.

### DESCRIPTION OF THE PREFERRED EMBODIMENTS

The proposed radial hydrostatic bearing according to the invention is described below in connection with a slide which is traversable in the horizontal direction and which is accommodated in a further slide. It is of no importance whether the further slide is likewise accommodated in a traversable manner in a horizontal or even in a vertical direction on a machining centre machining a workpiece to be machined. As used herein, a radial hydrostatic bearing is understood to comprise a bush 72, a first insert part 88 and a second insert part 90, respectively.

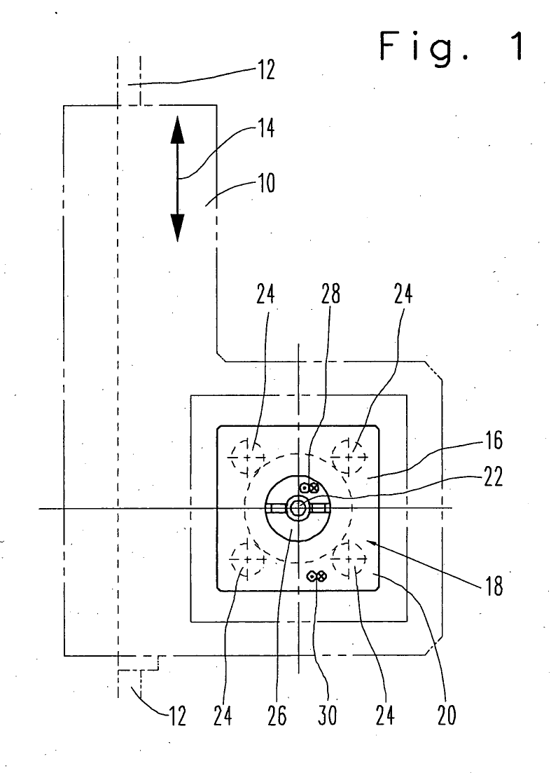

A side view of a vertical/horizontal slide 10 can be seen from the illustration according to FIG. 1. The vertical/horizontal slide 10 can be moved along a vertical guide 12, to mention one example. The vertical guide 12 may be a hydrostatic guide or a rolling guide, a sliding guide, a linear guide or a dovetail guide in order to achieve highly precise positioning of the vertical/horizontal slide 10 relative to the workpiece to be machined. A spindle slide 16 is accommodated in a traversable manner in the vertical/horizontal slide 10. The spindle slide 16 performs, for example, a horizontal traverse movement which is identified by reference numeral 30 and passes perpendicularly through the drawing plane according to FIG. 1. The end face of the spindle slide 16 is designated by reference numeral 18. A connecting surface 20 for a unit can be accommodated on the end face 18, and a unit expanding the functionality of the tool spindle slide 16 can be connected to said connecting surface 20. The fastenings for a unit (not shown in FIG. 1) are identified by reference numeral 24. Opening out in the connecting surface 20 are media lines, via which media, such as, for example, hydraulics or signal lines for sensory technology and electrical energy, can be supplied to the unit that can be optionally fastened to the end face 18 and is intended for expanding the functionality of the spindle slide 16. A tool spindle 26, likewise traversable in the horizontal direction, is accommodated in the spindle slide 16. The tool spindle 26 comprises a tool holder 22 and likewise performs a horizontal traverse movement, indicated by reference numeral 28 in FIG. 1.

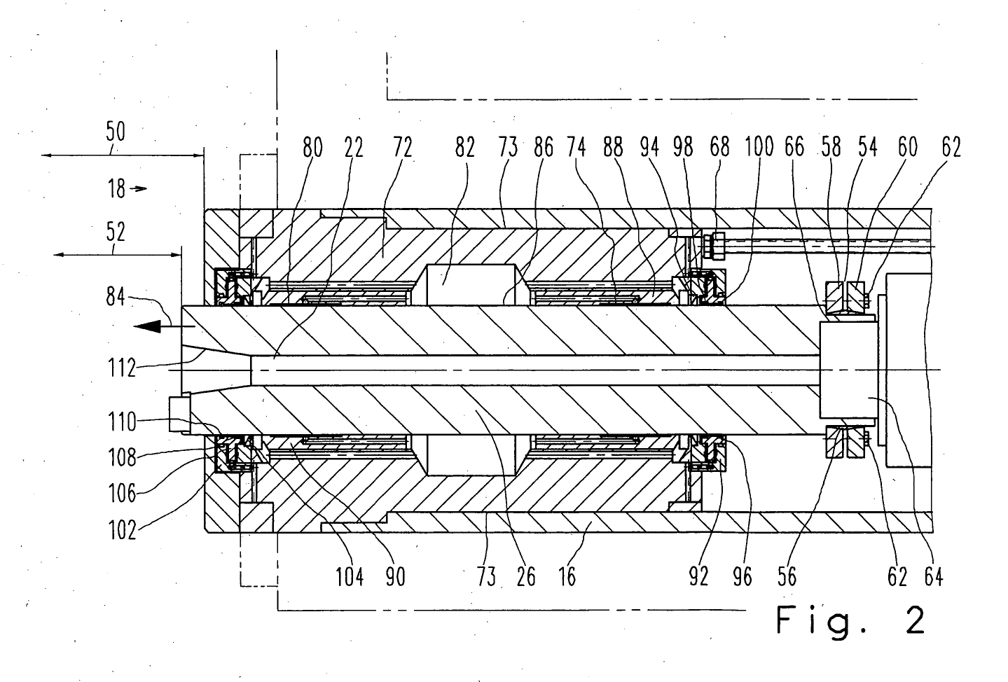

FIG. 2 shows a section through the workpiece-side end of the spindle slide 16, in which a tool spindle 26 traversable relative to the spindle slide 16 is mounted and guided in a radial hydrostatic bearing sealed according to the invention, and described more fully herein below.

FIG. 2 shows that the spindle slide 16 can be traversed by a traverse distance 50 of, for example, 1500 mm extending in the horizontal direction. The tool spindle 26 is movable relative to the spindle slide 16 by the traverse distance 52, likewise extending in the horizontal direction. The end face of the spindle slide 16 is designated by reference numeral 18, while the end face of the tool spindle 26 extendable from the spindle slide 16 is designated by reference numeral 118.

As can be seen from the illustration according to FIG. 2, the tool spindle 26 is connected by means of an overload safety device 54 (indicated by broken lines) to an output 64 of a gearing, which is not shown in FIG. 2 and via which the rotary movement of a drive is transmitted to a tool spindle 26 accommodating a tool or a unit. For graphic reasons, the tool spindle 26 is not shown in its full length, such that the position of the overload safety device 54 also does not correspond to the true position of the overload safety device in operation.

The overload safety device 54 comprises a shrink-fit seat 66, via which the tool spindle 26 is connected to the output 64 of the gearing. Located at the circumference 86 of the tool spindle 26 is a ring 56, the outer circumferential surface of which is preferably of beveled design. Accommodated on the outer circumferential surface of the ring 56 are a first clamping ring 58 and a second clamping ring 60, which are restrained together in the axial direction via a plurality of prestressing elements or bolts 62. By means of this solution, a defined slip torque resulting from the prestressing force and the surface pressure at the shrink-fit seat 66 can be set at the overload safety device 54, the tool spindle 26 slipping relative to the output 64 if said slip torque is exceeded, such that spindle and drive do not sustain any damage.

It can also be seen from the illustration according to FIG. 2 that the tool spindle 26 is mounted in a sealed radial hydrostatic bearing comprising a bush 72 which, in turn, encloses a first insert part 88 and a second insert part 90. At least one pocket 74 is formed in the first insert part 88 of the bush 72. A pressure medium, e.g. oil, is admitted to the pocket 74 via a pressure-medium supply 68. A pressure cushion is built up in the at least one pocket 74 by the pressure medium. Furthermore, the bush 72 encloses the second insert part 90, in which at least one pocket 80 is accommodated. The pressure-medium supply 68 to the pockets 74 and 80 formed in the insert parts 88 and 90 and holding pressure medium can be effected, for example, via a cavity 82 which is formed in the bush 72 and into which the pressure-medium supply 68 referred to opens out.

The sealed radial hydrostatic bearing according to the sectional illustration in FIG. 2 is designed in such a way that guidance of the tool spindle 26 essentially free of play is achieved in the radial hydrostatic bearing. There is an extremely small gap between the edges of the pockets 74 and 80 and the circumference 86 of the tool spindle 26. On account of this small gap and the special configuration of the pocket edges, the possibly requisite exchange of the tool spindle 26 if “striking” occurs, i.e. if a collision occurs between the tool spindle 26 and the workpiece to be machined, can be achieved with a short setting-up time. To exchange the tool spindle 26, first of all, after release of the overload safety device 54, it is necessary to remove a connecting surface 20, possibly provided on the end face 18 of the tool spindle 26, for a unit. The bush 72 can then be withdrawn from the spindle slide 16 traversable in the horizontal direction.

Due to the seal, proposed according to the invention, of the hydrostatic bearing of the tool spindle 26, the highly precise guidance of the latter is achieved in the region in which the maximum radial forces act on the driven tool spindle 26 during the machining of workpieces, to be machined, by the tool.

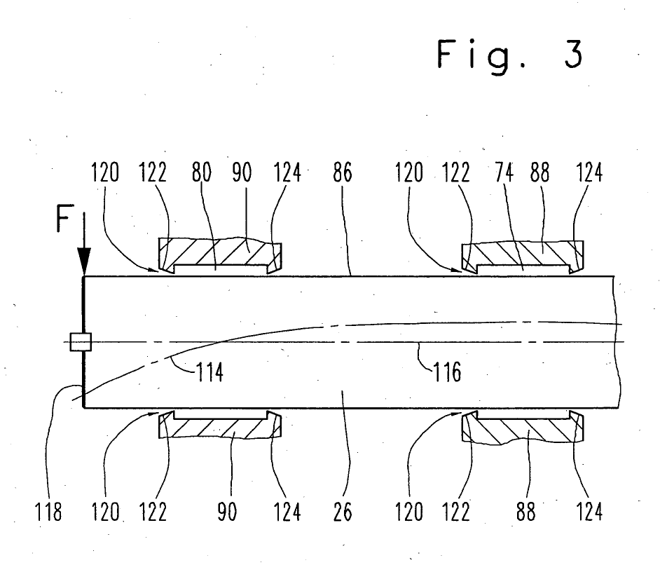

Furthermore, it can be seen from the illustration according to FIG. 2 that the radial hydrostatic bearing is sealed in the bush 72 by a first seal 92 and a second seal 102 at the end pointing towards the overload safety device 54 and at the end pointing towards the end face 18 of the spindle slide 16. The first seal 92, which is accommodated in the axial direction behind the first insert part 88, comprises a first radial seal 94 and a first axial seal 96. Whereas the first radial seal 94 may be designed, for example, as a sealing ring, the first axial seal 96 is formed by an annular component in which a first sealing element 98 and a second sealing element 100 are embedded. Said first and second sealing elements 98, 100 rest on the circumference 86 of the tool spindle 26 and wipe the pressure medium during the traverse of the tool spindle 26 in the horizontal direction 52 relative to the spindle slide 16. In the region of the end face 18, the second insert part 90, in which the pockets 80 are formed, is likewise sealed by the second seal 102. The second seal 102 comprises a second radial seal 104, which is preferably likewise designed as a sealing ring. Furthermore, the second seal 102 comprises a second axial seal 106, in which a third sealing element 108 and a fourth sealing element 110 are embedded. An escape of pressure medium from the pockets 74, 80 of the radial hydrostatic bearing at the end face 18 pointing towards the workpiece can be advantageously avoided by means of the second seal 102 in the region of the end face 18 of the spindle slide 16. Shown in FIG. 3 is a pneumatic bearing arrangement 126 to which compressed air is supplied which significantly reduces the power loss due to friction during the rotation of the tool spindle with respect to the seal.

It should also be mentioned that a taper 112 is assigned to the tool holder 22 incorporated in the tool spindle 26.

FIG. 3 shows the configuration of the pressure-medium pockets of the radial hydrostatic bearing according to FIG. 2.

It can be seen from the schematically illustrated FIG. 3 that the pockets 74, 80 (here shown simplified) formed in the first insert part 88 and the second insert part 90, respectively, are defined by pocket bevels 120. The pocket bevels 120 formed on pocket webs are formed on one side with a first slope 122 and on the other side with a second slope 124. In addition, it can be seen from the illustration according to FIG. 3 that, at the highest prominence of the pocket webs at the first insert part 88 and the second insert part 90, a gap forms between the pocket webs and the circumference 86 of the tool spindle 26. This gap is extremely small. The gap size in the radial hydrostatic bearing extends around the circumferential surface 86.

The tool spindle 26 has a symmetry line 116; in the event of loading at the end face 118 of the tool spindle 26, which occurs, for example, during the machining of a workpiece to be machined, the tool spindle 26 deforms in accordance with the bending line identified by reference numeral 114 according to FIG. 3.

The pocket webs which are provided with pocket bevels 120, and which define the pockets 74, 80 in the first insert part 88 and in the second insert part 90, advantageously ensure that, after the working surface 20 in the connection of a unit has been removed from the end face 118 of the tool spindle 26 or from the end face 18 of the spindle slide 16, the bush 72 can be withdrawn in withdrawal direction 84 from its bearing surface 73 on the inner surface of the spindle slide 16. As a result, compared with known solutions from the prior art, a defective tool spindle 26 can be exchanged very quickly from the spindle slide 16.

On account of the design of the radial hydrostatic bearing with at least two pockets 74, 80, a very long axial guide region of the tool spindle 26 subjected to maximum machining forces F can be achieved, which makes possible highly precise machining accuracies, not least on account of the small hydrostatic gap of the radial hydrostatic bearing.

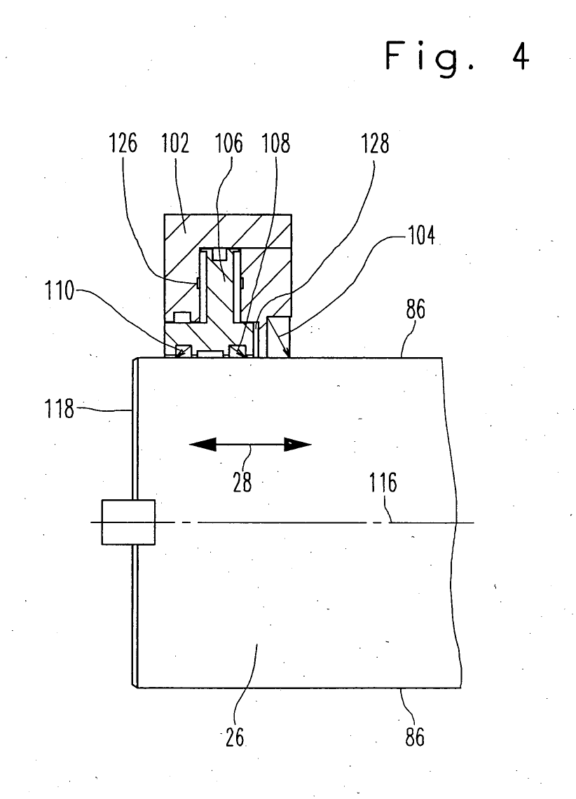

One of the seals of the radial hydrostatic bearing and of the tool spindle 26 enclosed by it can be seen in a schematic view, but on an enlarged scale, from the illustration according to FIG. 4.

It follows from the illustration according to FIG. 4 that the second seal 102 comprises the second axial seal 106. The second axial seal 106 is of essentially annular design and is fixed in the axial direction by means of a pneumatic bearing arrangement 126. With a region which points towards the circumferential surface 86 of the tool spindle 26, the second axial seal 106 is designed to be extended in the axial direction and encloses a ring and also the third sealing element 108 and the fourth sealing element 110. In the direction of the horizontal traverse movement 28 of the tool spindle 26, the third sealing element 108 lies in front of the fourth sealing element 110. Both sealing elements 108 and 110 are in contact with the circumferential surface 86 of the tool spindle 26. The ring arranged between the circumference 86 of the tool spindle 26 and the second axial seal 106 causes the second axial seal 106 to rotate with the tool spindle 26 and move in the housing relative to the pneumatic bearing arrangement 126. Compared with conventional solutions, the power loss and the heating of the tool spindle 26 is decisively reduced hereby. Consequently, the cooling of the tool spindle 26 can also be designed for lower cooling capacities. In addition, the second seal 102 comprises the second radial seal 104 of annular design. The second radial seal 104 is preferably designed as a sealing ring and bears against that boundary surface of the cavity 128 which faces away from the end face 118 of the tool spindle 26.

Whereas the second seal 102, shown in FIG. 4, is accommodated at that end face 118 of the tool spindle 26 which faces the workpiece, the tool spindle 26 being traversable axially with respect to the second seal 102, the first seal 92 rests on the side pointing towards the overload safety device 54 and likewise comprises the pneumatic bearing arrangement 126 for reducing the power loss and for the low-friction design of the axial seal.

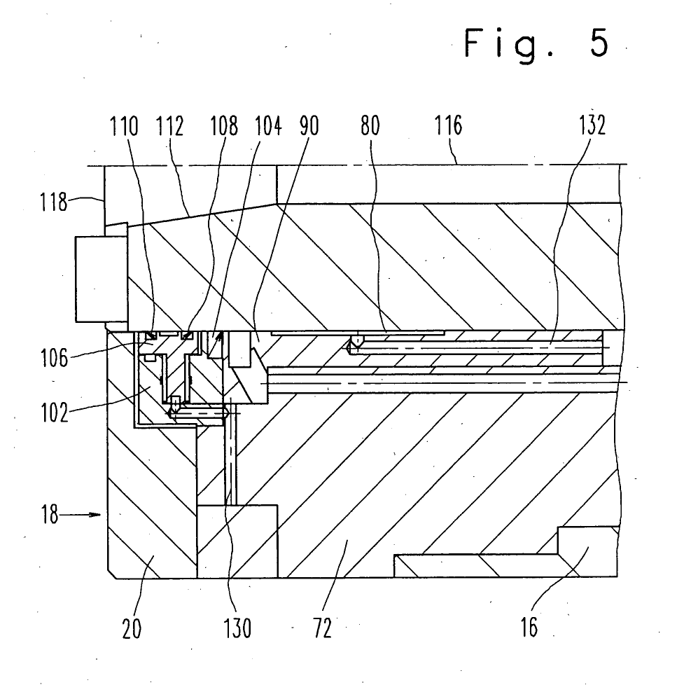

A section through the workpiece-side end of the tool spindle which is guided in the spindle slide and can be extended from the latter can be seen from the illustration according to FIG. 5.

It can be seen from the illustration according to FIG. 5 that the connecting surface 20 for accommodating a unit (not shown in FIG. 5) is fastened to the end face 18 of the spindle slide 16. The connecting surface 20 for the unit into which the cutting tool for the workpiece to be machined can be optionally admitted serves to expand the functionality of the tool spindle 26. Various machining planes and machining angles can be achieved via the unit, such that the clamping position of the workpiece to be machined relative to the tool spindle 26 and relative to the spindle slide 16 need not be changed. A unit is preferably used when the horizontal transverse movement of both the tool spindle 26 and the spindle slide 16 is not sufficient in order to reach the corresponding point or the corresponding surface of the workpiece to be machined.

It can also be seen from FIG. 5 that a compressed-air connection 130 runs inside the bush accommodating the second insert part 90 to the seal 102. The compressed-air connection 130 according to the illustration in FIG. 5 serves to pressurize the pneumatic bearing arrangement 126, indicated schematically in FIG. 4, of the second axial seal 106. Located in front of the latter in the axial direction is the second radial seal 104. The axial extent of the pocket 80 which is formed in the first insert part 90 can also be seen from the illustration according to FIG. 5. The first insert part 90 is in turn enclosed by the exchangeable bush 72, which, in order to exchange the tool spindle 26, can be withdrawn from the horizontally traversable spindle slide 16 in withdrawal direction 84 according to the illustration in FIG. 2 should the exchange of the tool spindle 26 be necessary.

The at least one pressure-medium pocket 80 in the first insert part 90 is pressurized via a pressure-medium bore 132 running axially in the first insert part 90. The radial hydrostatic bearing according to the embodiment shown in FIG. 5 is therefore formed by the bush 72, which is mounted in a fixed position in the spindle slide 16 and encloses the first insert part 90 with the at least one pressure-medium pocket 80 formed therein. The rotating part of the radial hydrostatic bearing is formed by the circumference 86 of the tool spindle 26, the tool-side end face of which is identified by reference numeral 118.

The foregoing relates to preferred exemplary embodiments of the invention, it being understood that other variants and embodiments thereof are possible within the spirit and scope of the invention, the latter being defined by the appended claims.

1. Tool spindle (26) for machining centers for the machining of workpieces which are mounted in an extendable manner in a spindle slide (16), the tool spindle (26) being accommodated in a radial hydrostatic bearing which is sealed on at least one side in the axial direction, the improvement comprising a low-friction axial seal (96, 106), which has a pneumatic bearing, said axial seal (106) rotating with the tool spindle (26).

2. Tool spindle (26) according to claim 1, wherein the radial hydrostatic bearing comprises a seal (102) at least on the side pointing towards the workpiece, which seal (102) includes a radial seal (104) and an axial seal (106) mounted in a low-friction manner.

3. Tool spindle (26) according to claim 1, wherein the radial hydrostatic bearing comprises a first seal (92) and a second seal (102) arranged at an end face (118) of the tool spindle (26).

4. Tool spindle (26) according to claim 3, wherein the seals (92, 102) comprise a first and a second axial seal (96, 106), respectively, and a first and a second radial seal (94, 104), respectively.

5. Tool spindle (26) according to claim 4, wherein the first and second axial seals (96, 106) comprise a first and a second sealing element (98, 100) and respectively a third and a fourth sealing element (108, 110), which are in contact with the circumferential surface (86) of the tool spindle (26).

6. Tool spindle (26) according to claim 4, wherein the axial seal (96, 106) mounted in a low-friction manner is accommodated on the circumference (86) of the tool spindle (26) by means of a ring and rotates with the tool spindle (26) in a relative manner in the pneumatic bearing arrangement (126).

7. Tool spindle (26) according to claim 4, wherein the first and the second radial seal (94, 104) are designed as sealing rings and are each arranged in front of a cavity (128) in which the first seal (96) or the second seal (106) are accommodated.

8. Tool spindle (26) according to claim 1, wherein the radial hydrostatic seal comprises a bush (72) having a first insert part (88) and a second insert part (90).

9. Tool spindle (26) according to claim 1, wherein the radial hydrostatic bearing comprises at least two pressure-medium pockets (74, 80).

10. Tool spindle (26) according to claim 9, wherein the pressure-medium pockets (74, 80) are formed in the first insert part (88) and in the second insert part (90).

11. Tool spindle (26) according to claim 10, wherein the pressure-medium pockets (74, 80) enclose the circumference (86) of the tool spindle (26) over an axial length.

12. Tool spindle (26) according to claim 9, further comprising a pressure-medium supply (68) opening into a cavity (82) of the bush (72), and pressure-medium bores (132) extending through the insert parts (88, 90) to the pressure-medium pockets (74, 80).

13. Tool spindle (26) according to claim 1, wherein the pressure-medium pockets (74, 80) are defined by webs having pocket bevels (120) on their sides pointing towards the circumference (86) of the tool spindle (26).

14. Tool spindle (26) according to claim 13, wherein the pocket bevels (120) have a first slope (122) or a second slope (124).

15. Tool spindle (26) according to claim 1, wherein the bush (72) is guided in the tool spindle (26) in a bearing surface (73) and can be withdrawn from the tool spindle (26) from an end face (118) in withdrawal direction (84).
